(19) United States
(12) Patent Application Publication
(10) Pub. No.: US 2019/0148898 A1
(43) Pub. Date: May 16, 2019

(54) CONNECTOR ORIENTATIONS

(71) Applicant: HEWLETT-PACKARD DEVELOPMENT COMPANY, L.P., Houston, TX (US)

(72) Inventors: Connor Jam WATKINS, Fort Collins, CO (US); Amol Subhash PANDIT, Fort Collins, CO (US); Peter Andrew SEILER, Fort Collins, CO (US); Christopher Ritchie TABAREZ, Fort Collins, CO (US)

(73) Assignee: HEWLETT-PACKARD DEVELOPMENT COMPANY, L.P., Houston, TX (US)

(21) Appl. No.: 16/097,358

(22) PCT Filed: Apr. 28, 2016
(86) PCT No.: PCT/US2016/029678

§ 371 Date: Oct. 29, 2018

(51) Int. Cl. H01R 29/00; H01R 13/66; H01R 13/717

(52) U.S. Cl. CPC H01R 29/00; H01R 13/7175; H01R 13/665

(57) ABSTRACT

An example device includes a port to receive a connector; at least two functions accessible through the port; and a controller coupled to the port. The controller includes an orientation detection portion to determine an orientation of the connector when received by the port, the orientation being one orientation of at least two possible orientations in which the connector may be received by the port; and a function selection portion to select, based on the determined orientation, at least one function of the at least two functions to be made accessible through the connector.

### BACKGROUND

Connectors are regularly used to connect various devices to one another. A connector at one end of a cable, for example, is typically inserted into or interfaced with a port in one device. The connection is made by mating of contacts in the port with contacts in the connector. In this regard, the device may communicate with a second device on the other end of the cable.

### BRIEF DESCRIPTION OF THE DRAWINGS

For a more complete understanding of various examples, reference is now made to the following description taken in connection with the accompanying drawings in which:

FIG. 1 is a schematic illustration of an example device with a connector port;

FIG. 2 is a schematic illustration of an example system with a host device having a connector port;

FIG. 3 is a schematic illustration of an example system with a peripheral device having a connector port;

FIG. 4 is a schematic illustration of an example system with a host device and a peripheral device each having a connector port;

FIG. 5 illustrates a contact arrangement in an example port having two orientations;

FIG. 6 illustrates a contact arrangement in an example port having four orientations;

FIG. 7 illustrates a contact arrangement in an example port having three orientations;

FIG. 8 is a schematic illustration of another example device with a connector port;

FIG. 9 is a schematic illustration of another example device with a connector port with a cable connected to the connector port;

FIG. 10 is a flow chart illustrating an example process for connector orientation; and

FIG. 11 illustrates a block diagram of an example system with a computer-readable storage medium including instructions executable by a processor for connector orientation.

### DETAILED DESCRIPTION

Various examples described herein provide for using the orientation of a connector, such as a reversible connector, to selectively provide functionality. When a connector is inserted into a port of a device, the device may determine the orientation and, based on the orientation, select the functionality to be provided through the port. The device may be a host device or an accessory, or auxiliary device. In one example, the orientation of the connector may be used to configure at least one of the contacts to be a power pin to, for example, provide power (or additional power) to the device. In some examples, the device may include indicators, such as light emitting diodes (LEDs), which may be selectively activated to indicate the orientation of the connector or the functionality being provided based on the orientation. In some examples, the selective activation may be achieved by a controller of the device, circuitry provided in the device, the connector or a cable connected to the connector, or a combination thereof.

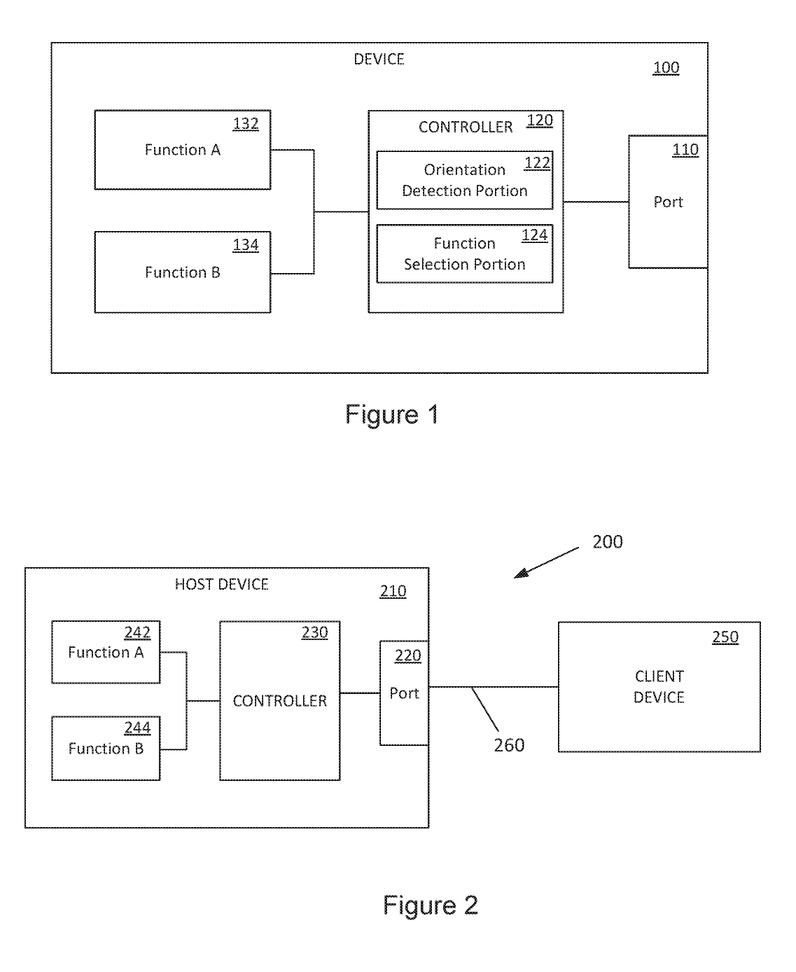

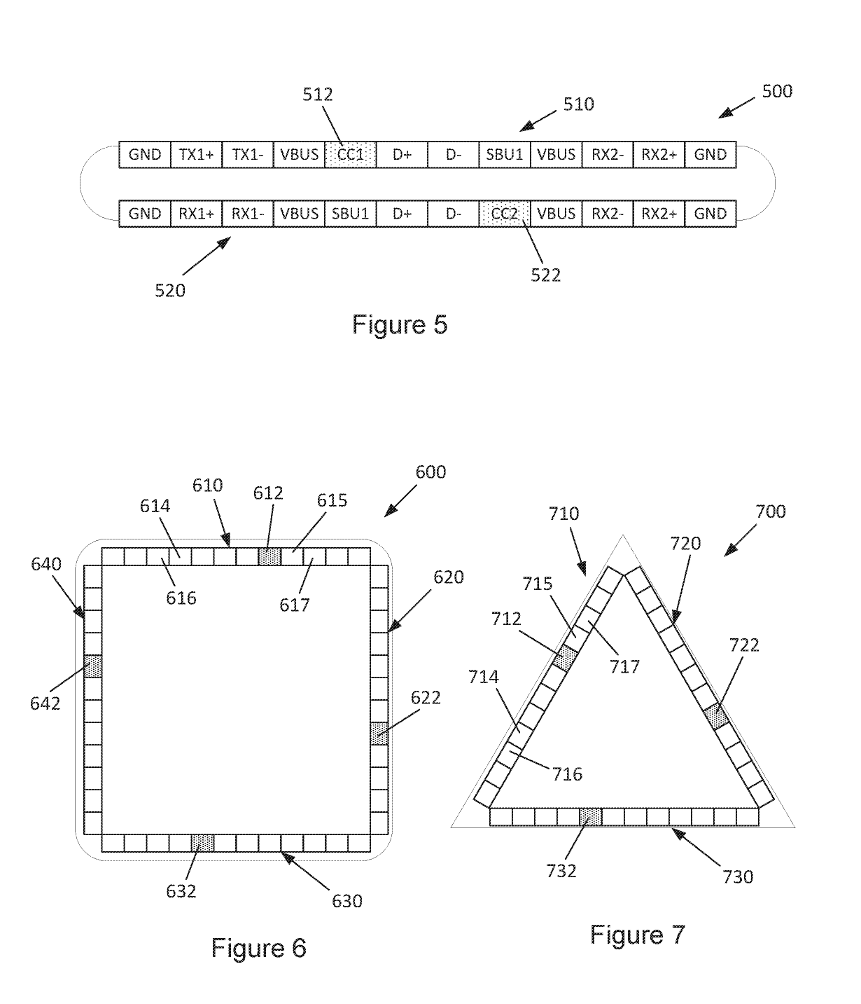

Referring now to the figures, FIG. 1 illustrates an example device 100 which may use the orientation of a connector to selectively provide functionality. The example device 100 of FIG. 1 may be any of a variety of electronic devices including, but not limited to, a laptop computer, desktop computer, smartphone, tablet, printer, cable adapter, network adapter, docking station, a keyboard/video/mouse (KVM) switch, portable memory device or the like. In the example of FIG. 1, the example device 100 is provided with a port 110 which may receive a connector (not shown in FIG. 1). The connector may mate with the port 110 via a plurality of contacts, as described in greater detail below with reference to FIGS. 5-7. The port 110 of the example device 100 is capable of receiving a connector in one of at least two possible orientations. For example, the port 110 may receive a reversible connector in either of two orientations.

The example device 100 of FIG. 1 is provided with a controller 120 coupled to the port 110. The controller 120 may be, for example, a central processing unit (CPU) of the example device 100. In this regard, the controller 120 may include various other components not shown in FIG. 1 and not described herein for purposes of clarity. In other examples, the controller 120 may be implemented as hardware, firmware, software or a combination thereof.

The controller 120 of the example device 100 includes an orientation detection portion 122 and a function selection portion 124. The orientation detection portion 122 is provided to detect an orientation of a connector received by the port 110. As noted above, the port 110 may receive a connector in one orientation of at least two possible orientations. In this regard, the orientation detection portion 122 may identify at least one contact of the connector to determine or detect the orientation of the connector, for example.

The function selection portion 124 may select functionality of the device 100 to be made accessible through the port 110 based on the determined orientation of the connector received therein. In this regard, the example device 100 may be provided with at least two functions 132, 134. In various examples, the functions 132, 134 may include, for example, applications, features, data, or access rights available on the example device 100. For example, in the case of the example device 100 being a smart phone, the applications or features may include a photo library, a music application, a flashlight, etc. Thus, based on the orientation of the connector in the port 110, the controller 120 may, for example, enable access to the photo library and disable all other features.

As noted above, the example device 100 may receive a connector in the port 110, allowing the example device 100 to be connected to another device. For example, FIGS. 2-4 illustrate examples in which various example devices are connected to other devices through a port which may receive a connector in one orientation of at least two possible orientations.

Referring now to FIG. 2, an example system 200 includes a host device 210 connected to a client device 250. In various examples, the host device 210 may be a desktop computer, laptop, server, tablet, smartphone or any of a variety of other electronic devices, and the client device 250 may be any of a variety of other devices such as a portable memory device, a smartphone, docking station, KVM switch, etc. In the example of FIG. 2, the host device 210 is similar to the example device 100 of FIG. 1 and includes a port 220, a controller 230 and various functions 242, 244. Further, while not shown in FIG. 2, the controller 230 may include an orientation detection portion and a function selection portion similar to the portions 122, 124 described above with reference to FIG. 1.

As described above, the port 220 may receive a connector in one orientation of at least two possible orientations. In the example system 200 of FIG. 2, the port 220 is used to connect the host device 210 with the client device 250 by receiving a connector (not shown) at one end of a cable 260. The other end of the cable 260 is connected to the client device 250.

Depending on the orientation of the connector received in the port 220, the controller 230 may selectively allow access to various functions 242, 244 through the port 220. In this regard, the controller 230 may enable or disable at least one of the various functions 242, 244 through the port. For example, in one example, the host device 210 may be a laptop, and the client device 250 may be a smartphone. The port 220 may receive the connector in one or two orientations. In one orientation, the host device 210 may provide only certain access rights by, for example, allowing the client device 250 to access only the music library for synchronization but disable access to the photo library. In a second orientation, the host device 210 may provide full access rights by, for example, allowing complete access to all available functions including, for example, the power supply through which the client device 250 may charge itself. In various examples, in some orientations, additional contacts of the port 220 may be enabled to provide additional power for charging of the client device 250, while in other orientations, additional contacts of the port 220 may be enabled for additional data transmission, thereby providing additional data bandwidth.

In various examples, the functions 242, 244 selected based on the determined orientation of the connector may include user or device profiles. For example, the determined orientation of the connector may be used to associate the device 200 with a particular user. Thus, each orientation of the connector may be associated with a different user, for example. In other examples, configuration of the client device 250 may be based on the orientation of the connector received in the port 220. For example, in the case of a mouse, the client device 250 may be configured as a left-handed mouse with the connector in a first orientation and as a right-handed mouse with the connector in a second orientation. Similarly, in the case of a keyboard, the client device 250 may be configured as a QWERTY keyboard with the connector in a first orientation and as a Dvorak keyboard with the connector in a second orientation.

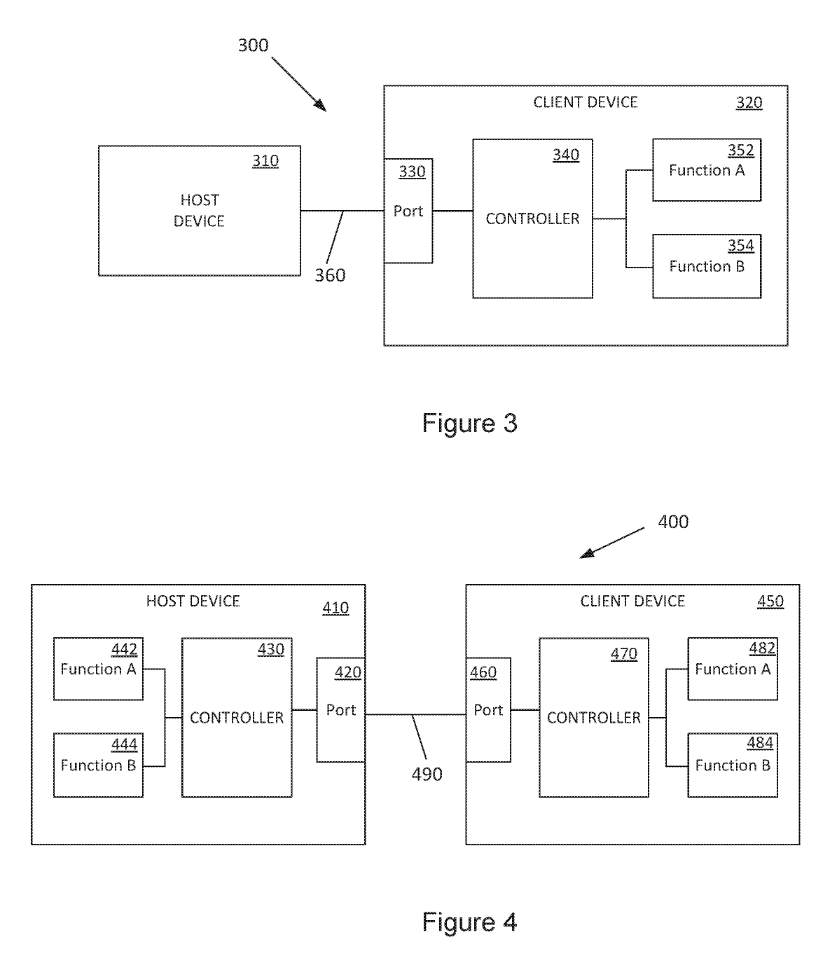

Referring now to FIG. 3, an example system 300 includes a host device 310 connected to a client device 320. As described above with reference to FIG. 2, in various examples, the host device 310 may be a desktop computer, laptop, server, tablet, smartphone or any of a variety of other electronic devices, and the client device 320 may be any of a variety of other devices such as a portable memory device, a smartphone, docking station, KVM switch, etc. In the example of FIG. 3, the client device 320 is similar to the example device 100 of FIG. 1 and includes a port 330, a controller 340 and various functions 352, 354. Again, while not shown in FIG. 3, the controller 340 may include an orientation detection portion and a function selection portion similar to the portions 122, 124 described above with reference to FIG. 1.

In the example system 300 of FIG. 3, the port 330 is used to connect the host device 310 with the client device 320 by receiving a connector (not shown) at one end of a cable 360. The other end of the cable 360 is connected to the host device 310. Depending on the orientation of the connector received in the port 330, the controller 340 may selectively allow access to various functions 352, 354 of the client device 320 through the port 330. For example, in one example, the host device 310 may be a laptop, and the client device 320 may be a smartphone. The port 330 may receive the connector in one or two orientations. In one orientation, the client device 320 may allow the host device 310 to access various features, such as the music or photo libraries. In a second orientation, the client device 320 may disable access to the music and photo libraries, but may allow the client device 320 to charge itself through the host device 310.

Referring now to FIG. 4, an example system 400 includes a host device 410 connected to a client device 450. Again, in various examples, the host device 410 may be a desktop computer, laptop, server, tablet, smartphone or any of a variety of other electronic devices, and the client device 450 may be any of a variety of devices such as a portable memory device, a smartphone, docking station, KVM switch, etc. In the example of FIG. 4, the host device 410 is similar to the example device 100 of FIG. 1 and includes a port 420, a controller 430 and various functions 442, 444. Further, in the example of FIG. 4, the client device 450 is also similar to the example device 100 of FIG. 1 and includes a port 460, a controller 470 and various functions 482, 484.

In the example system 400 of FIG. 4, the port 420 of the host device 410 is used to connect the host device 310 with the client device 450 by receiving a connector (not shown) at one end of a cable 490. Depending on the orientation of the connector received in the port 420, the controller 430 may selectively allow access to various functions 442, 444 of the host device 410 through the port 420. The other end of the cable 490 is connected to the client device 450, which also receives a connector at the second end of the cable in its port 460. Again, depending on the orientation of the connector received in the port 460, the controller 470 may selectively allow access to various functions 482, 484 of the client device 450 through the port 460. Thus, in the example of FIG. 4, each of the host device 410 and the client device 450 may selectively allow access to functions based on the orientation of the connector received in the respective port.

In various examples described above with reference to FIGS. 1-4, various example devices are provided with a port to receive a connector in one orientation of at least two possible orientations. Various examples of such ports are described below with reference to FIGS. 5-7.

Referring now to FIG. 5, an example port 500 is illustrated with arrangement of contacts which provide for two possible orientations, similar to a Universal Serial Bus Type-C. In this regard, the example port 500 is provided with two sets of contacts 510, 520. The first set of contacts 510 (on the top side of FIG. 5) and the second set of contacts 520 are substantially, identical and arranged in a mirrored configuration. Each set of contacts 510, 520 includes contacts for various functions such as power (e.g., GND, VBUS) and data communication (e.g., TX, RX).

The various contacts in the sets of contacts 510, 520 may mate with corresponding pins in a connector to allow communication between devices. In various examples, each set of contacts 510, 520 of the example port 500 includes contacts for mating with at least pin of the connector which indicates the orientation of the connector. For example, in the example of FIG. 5, the first set of contacts 510 includes a first configuration control contact (CC1) 512, and the second set of contacts 520 includes a second configuration control contact (CC2) 522. A controller of a device associated with the port 500 may include an orientation detection portion which determines the orientation of the connector by detecting the identity of the pin of the connector mated to one or both of the configuration control contacts 512, 522. Of course, in other examples, the orientation detection portion may detect a connector pin mating with any of various other contacts of the port 500 to determine orientation of the connector.

FIG. 5 illustrates the contact arrangement in an example port 500 for receiving a connector in one of two possible orientations. In other examples, a different number of possible orientations may be provided. For example, FIG. 6 illustrates an example port 600 for receiving a connector in one orientation of four possible orientations, and FIG. 7 illustrates an example port 700 for receiving a connector in one orientation of three possible orientations.

Referring now to FIG. 6, the example port 600 is provided with four sets of contacts 610, 620, 630, 640. The first set of contacts 610 (on the top side of FIG. 6), the second set of contacts 620 (on the right side of FIG. 6), the third set of contacts 630 (on the bottom of FIG. 6) and the fourth set of contacts 640 (on the left side of FIG. 6) are substantially identical and may include contacts for various functions such as power and data communication. Further, each set of contacts 610, 620, 630, 640 of the example port 600 includes contacts for mating with at least pin of the connector which indicates the orientation of the connector. For example, in the example of FIG. 6, the first set of contacts 610 includes a first configuration control contact 612, the second set of contacts 620 includes a second configuration control contact 622, the third set of contacts 630 includes a third configuration control contact 632, and the fourth set of contacts 640 includes a fourth configuration control contact 642. A controller of a device associated with the port 600 may include an orientation detection portion which determines the orientation of the connector by detecting the identity of the pin of the connector mated to at least one of the configuration control contacts 612, 622, 632, 642.

Similarly, the example port 700 illustrated in FIG. 7 is provided with three sets of contacts 710, 720, 730. The first set of contacts 710 (on the left side of FIG. 7), the second set of contacts 720 (on the right side of FIG. 7) and the third set of contacts 730 (on the bottom of FIG. 7) are substantially identical and may include contacts for various functions such as power and data communication. Further, each set of contacts 710, 720, 730 of the example port 700 includes contacts for mating with at least pin of the connector which indicates the orientation of the connector. For example, in the example of FIG. 7, the first set of contacts 710 includes a first configuration control contact 712, the second set of contacts 720 includes a second configuration control contact 722, and the third set of contacts 730 includes a third configuration control contact 732. A controller of a device associated with the port 700 may include an orientation detection portion which determines the orientation of the connector by detecting the identity of the pin of the connector mated to at least one of the configuration control contacts 712, 722, 732.

In various examples, the controller of the device associated with a port may configure at least one contact as a power transmission pin when the connector is detected in a particular orientation. For example, as illustrated in FIG. 6, when the connector received in the port 600 is determined to be in a first orientation, at least one contact (e.g., contacts 614-617) may be configured as data transmission pins. On the other hand, when the connector received in the port 600 is determined to be in a second orientation, the contacts 614-617 may be configured as power transmission pins. In this regard, the number of power transmission pins in the port 600 may be increased to, for example, increase the rate of charging of a device connected through the port 600.

Similarly, with reference to FIG. 7, when the connector received in the port 700 is determined to be in a first orientation, at least one contact (e.g., contacts 714-717) may be configured as data transmission pins. On the other hand, when the connector received in the port 700 is determined to be in a second orientation, the contacts 714-717 may be configured as power transmission pins.

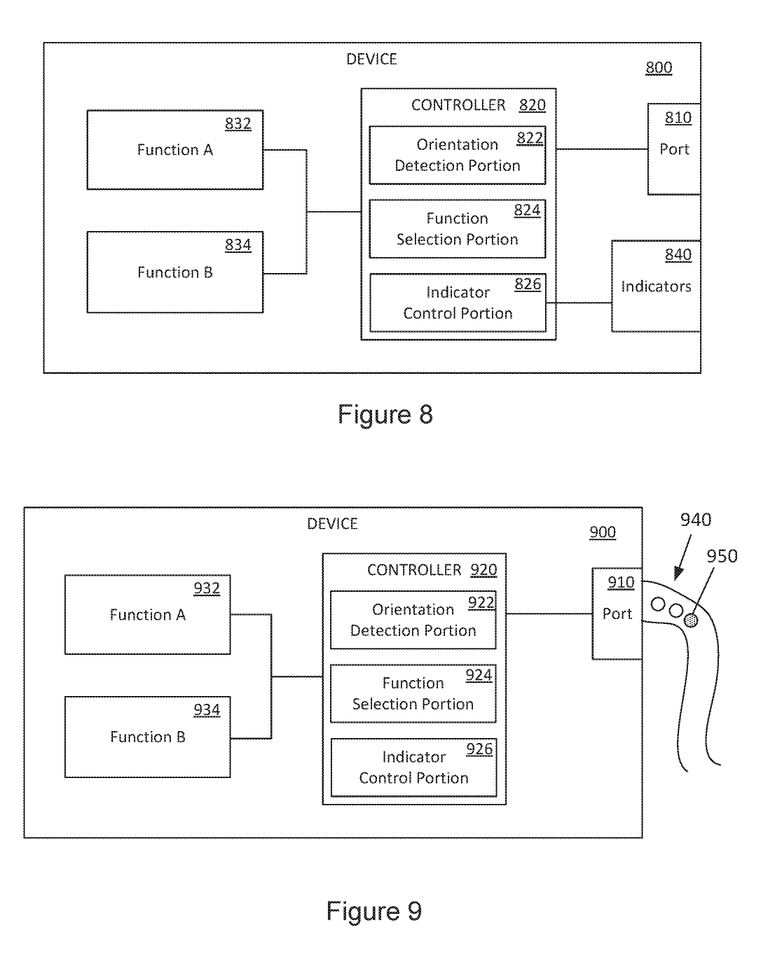

Referring now to FIG. 8, another example device with a connector port is schematically illustrated. The example device 800 of FIG. 8 is similar to the example device 100 described above with reference to FIG. 1 and includes a port 810, a controller 820 and various functions 832, 834. Further, the port 810 may receive a connector in one orientation of at least two possible orientations. As with the example device 100 of FIG. 1, the controller 820 of the example device 800 includes an orientation detection portion 822 and a function selection portion 824.

The example device 800 of FIG. 8 further includes an indicator control portion 826 to selectively activate at least one indicator 840 provided on the example device 800. In various examples, orientation detection portion 822 may determine the orientation of a connector received in the port 810, and the indicator control portion 826 may use the determined orientation to selectively activate the indicators 840. For example, the indicators 840 may indicate whether the connector is in a first, second, etc. orientation. In other examples, the indicators may be selectively activated to indicate the functions 832, 834 which are enabled for access through the port 810. In still other examples, the indicators may indicate a magnitude of at least one function. For example, the indicators 840 may be activated to indicate the rate of charging through power transmission pins of the port 810.

In various examples, the indicators 840 may be includes various types of indicators. For example, the indicators 840 may include a light emitting diode (LED), an organic light emitting diode (MID), an incandescent light, or a liquid crystal display (LCD).

Referring now to FIG. 9, another example device 900 with a connector port is schematically illustrated. The example device 900 of FIG. 9 is similar to the example device 800 described above with reference to FIG. 8 and includes a port 910, a controller 920 and various functions 932, 934. Further, the port 910 may receive a connector in one orientation of at least two possible orientations. As with the example device 800 of FIG. 8, the controller 920 of the example device 900 includes an orientation detection portion 922, a function selection portion 924 and an indicator control portion 926.

In the example of FIG. 9, a cable 940 is illustrated as extending from the port 910. In this regard, a connector (not shown) received in the port 910 may allow communication between the device 900 and another device through the cable 940. In the example device 900 of FIG. 9, the indicator control portion 926 may selectively activate indicators 950 which are positioned on the cable connected to the connector received in the port 910. In another example, the cable 940 may include circuitry to passively activate indicators 950 without the selection of an indicator control portion.

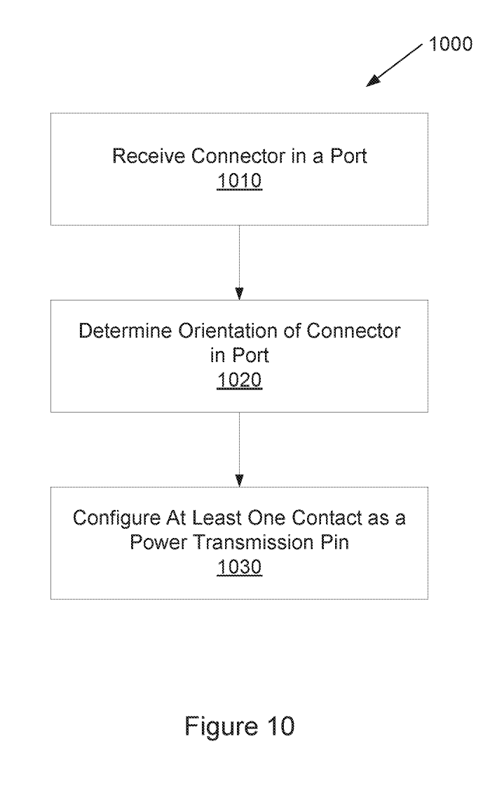

Referring now to FIG. 10, a flow chart illustrates an example method for connector orientation. The example method 1000 may be implemented in various devices, including the example devices described above with reference to FIGS. 1-9. In accordance with the example method 1000, a connector may be received in a port (block 1010). In various examples, the connector may mate with the port through various contacts in the port.

At block 1020, an orientation of the connector in the port is determined. As described above, in various examples, the port is to receive the connector in one orientation of at least two orientations. The orientation of the connector may be determined by detecting at least one pin of the connector mating with a contact of the port, such as a configuration control contact.

At block 1030 of the example method 1000, at least one contact of the port is configured as a power transmission pin. In various examples, each orientation of at least two possible orientations of the connector may correspond to a different number of contacts of the port being configured as power transmission pins.

Of course, the example method 1000 may include various other features not illustrated in FIG. 10. For example, the method 1000 may further include selectively activating various indicators based on the determined orientation of the detector.

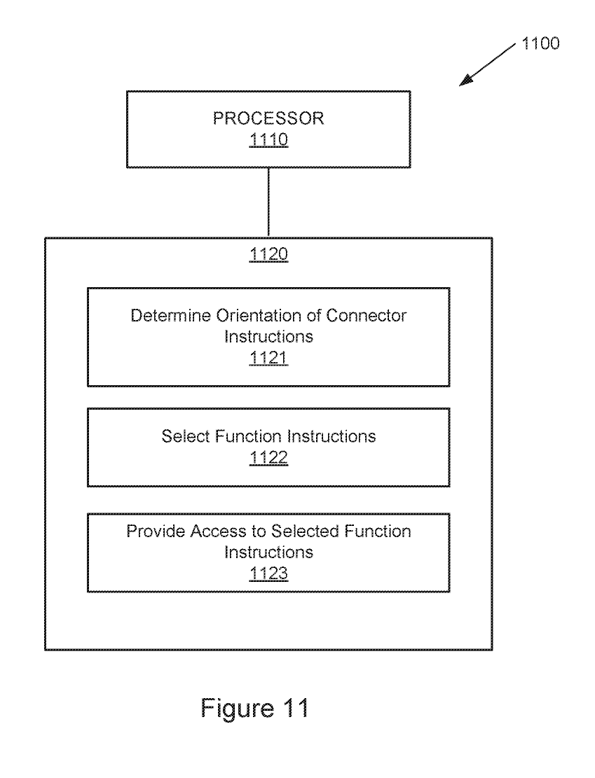

Referring now to FIG. 11, a block diagram of an example system is illustrated with a non-transitory computer-readable storage medium including instructions executable by a processor for fulfilling an access request. The system 1100 includes a processor 1110 and a non-transitory computer-readable storage medium 1120. The computer-readable storage medium 1120 includes example instructions 1121-1123 executable by the processor 1110 to perform various functionalities described herein. In various examples, the non-transitory computer-readable storage medium 1120 may be any of a variety of storage devices including, but not limited to, a random access memory (RAM) a dynamic RAM (DRAM), static RAM (SRAM), flash memory, read-only memory (ROM), programmable ROM (PROM), electrically erasable PROM (EEPROM), or the like. In various examples, the processor 1110 may be a general purpose processor, special purpose logic, or the like.

The example instructions include determine orientation of connector instructions 1121. As described above, when a connector is received in a port of a device in one orientation of at least two possible orientations, the orientation of the connector in the port may be determined by, for example, detecting a pin of the connector.

The example instructions further include select function instructions 1122. In this regard, based on the determined orientation of the connector, at least one function of various functions available on the device may be selected.

The example instructions further include provide access to selected function instructions 1123. The functions selected based on the orientation of the connected may be made available through the port. In this regard, various functions may be enabled or disabled through the port based on the orientation of the connector in the port.

Thus, in accordance with various examples described herein, orientation of a connector may be used to selectively provide (e.g., enable or disable) functionality of a device. Further, indicators may be provided to provide indications of the orientation of the connector and/or the selected functionality, for example.

Software implementations of various examples can be accomplished with standard programming techniques with rule-based logic and other logic to accomplish various database searching steps or processes, correlation steps or processes, comparison steps or processes and decision steps or processes.

The foregoing description of various examples has been presented for purposes of illustration and description. The foregoing description is not intended to be exhaustive or limiting to the examples disclosed, and modifications and variations are possible in light of the above teachings or may be acquired from practice of various examples. The examples discussed herein were chosen and described in order to explain the principles and the nature of various examples of the present disclosure and its practical application to enable one skilled in the art to utilize the present disclosure in various examples and with various modifications as are suited to the particular use contemplated. The features of the examples described herein may be combined in all possible combinations of methods, apparatus, modules, systems, and computer program products.

It is also noted herein that while the above describes examples, these descriptions should not be viewed in a limiting sense. Rather, there are several variations and modifications which may be made without departing from the scope as defined in the appended claims.

What is claimed is:

1. A device, comprising:
a port to receive a connector;
at least two functions accessible through the port; and
a controller coupled to the port, the controller comprising:
an orientation detection portion to determine an orientation of the connector when received by the port, the orientation being one orientation of at least two possible orientations in which the connector may be received by the port; and
a function selection portion to select, based on the determined orientation, at least one function of the at least two functions to be made accessible through the connector.

2. The device of claim 1, wherein the orientation detection portion determines the orientation of the connector by detecting at least one pin of the connector indicative of the orientation.

3. The device of claim 1, wherein the function selection portion enables the selected at least one function and disables at least one other function.

4. The device of claim 1, wherein the controller further comprises an indicator control portion to selectively activate at least one indicator based on the determined orientation.

5. The device of claim 4, wherein the at least one indicator is positioned on at least one of the device, the connector, or a cable connected to the connector.

6. The device of claim 4, wherein the at least one indicator is at least one of a light emitting diode (LED), an organic light emitting diode (OLED), an incandescent light, or a liquid crystal display (LCD).

7. The device of claim 4, wherein the indicator portion selectively activates the at least one indicator to indicate the selected at least one function.

8. The device of claim 4, wherein the indicator portion selectively activates the at least one indicator to indicate a magnitude of at least one function.

9. A method, comprising:
receiving a connector in a port of a device, the connector mating with the port via a plurality of contacts;
determining an orientation of the connector in the port; and
configuring at least one of the plurality of contacts, based on the orientation of the connector, as a power transmission pin,
wherein a number of contacts configured as power transmission pins is based on the orientation of the connector in the port.

10. The method of claim 9, wherein the port is configured to receive the connector in one orientation of at least two orientations.

11. The method of claim 10, wherein each orientation of the at least two orientations corresponds to a different number of plurality of contacts being configured as power transmission pins.

12. The method of claim 9, further comprising:
selectively activating at least one indicator based on the determined orientation.

13. A non-transitory computer-readable storage medium encoded with instructions executable by a processor of a computing system, the computer-readable storage medium comprising instructions to:
determining an orientation of a connector in a port of a device;
select, based on the determined orientation, at least one function of at least two functions available on the device;
provide access to the selected at least one function through the port.

14. The non-transitory computer-readable storage medium of claim 13, further comprising instructions to:
enable the selected at least one function and disable at least one other function.

15. The non-transitory computer-readable storage medium of claim 14, further comprising instructions to:
selectively activating at least one indicator based on the determined orientation.
